(19) United States
(12) Patent Application Publication
(10) Pub. No.: US 2026/0220717 A1
(43) Pub. Date: Jul. 30, 2026

(54) TAX DATA RECONCILIATION ENGINE

(71) Applicant: Vertex, Inc., King of Prussia, PA (US)

(72) Inventors: David Reinke, Northville, MI (US); James Edwards, Haverford, PA (US); Kent Kingery, Boerne, TX (US); Uma Anmangandla, Lansdale, PA (US); Isabelle Desmeytere, Grimbergen (BE); Khaled Abdou, Broomall, PA (US); Terry Hardin, Secaucus, NJ (US)

(21) Appl. No.: 19/437,008

(22) Filed: Dec. 30, 2025

Related U.S. Application Data
(60) Provisional application No. 63/751,760, filed on Jan. 30, 2025.

(51) Int. Cl. G06Q 40/12

(52) U.S. Cl. CPC G06Q 40/123

(57) ABSTRACT

A computing system for reconciling tax data includes processing circuitry that implements a tax data reconciliation program. The processing circuitry receives a command to reconcile a first tax data set with a second tax data set, receives the first and second tax data sets, the second tax data set having a second tax data format different from a first tax data format of the first tax data set. The processing circuitry retrieves a data set configuration, and records between the first tax data set and the second tax data set are matched via the first key and the second key. Fields in the first data range are compared with corresponding fields in the second data range, and comparison results are stored. A tax data reconciliation report including the comparison results for the compared fields is generated.

### CROSS REFERENCE TO RELATED APPLICATIONS

This application claims priority to U.S. Provisional Patent Application Ser. No. 63/751,760 filed Jan. 30, 2025, the entirety of which is hereby incorporated herein by reference for all purposes.

### BACKGROUND

Taxes on goods and services are calculated to meet legislative requirements, such as indirect taxes, including sales tax, use tax, value added tax (VAT), and goods and services tax (GST), depending on the circumstances, jurisdiction, and the like. Businesses may use customer systems and third-party applications to calculate taxes and store tax data for reporting and compliance. However, tax data generated by different systems and applications may be in various formats, which requires manual reconciliation prior to reporting. Unfortunately, manual reconciliation can be an inefficient and error-prone task.

### SUMMARY

To address these issues, systems and methods for reconciling tax data are disclosed herein. According to one aspect, a computing system for reconciling tax data is provided, including a computing device with processing circuitry configured to execute instructions using portions of associated memory to implement a tax data reconciliation program. Implementation of the tax data reconciliation program causes the processing circuitry to receive a command to reconcile a first tax data set with a second tax data set. The command specifies one or more fields to be compared between the first tax data set and the second tax data set. The processing circuitry receives the first tax data set and the second tax data set. The first tax data set has a first tax data format, and the second tax data set has a second tax data format that is different from the first tax data format. The processing circuitry retrieves at least one stored configuration file containing a first key and a first data range for the first tax data set, and a second key and a second data range for the second data set. A tax data reconciliation algorithm is implemented to match records between the first tax data set and the second tax data set via the first key and the second key, compare fields in the first data range with corresponding fields in the second data range, and store comparison results for each set of compared fields. A tax data reconciliation report is generated, including the comparison results for each set of compared fields.

According to another aspect, a method for reconciling tax data is provided. The method includes receiving a command to reconcile a first tax data set with a second tax data set, the command specifying one or more fields to be compared between the first tax data set and the second tax data set; receiving the first tax data set, the first tax data set having a first tax data format; receiving the second tax data set, the second tax data set having a second tax data format different from the first tax data format; receiving at least one stored configuration file containing a first key and a first data range for the first tax data set, and a second key and a second data range for the second tax data set; implementing a tax data reconciliation algorithm, the tax data reconciliation algorithm being configured to perform the steps of matching records between the first tax data set and the second tax data set via the first key and the second key, comparing fields in the first data range with corresponding fields in the second data range, and storing comparison results for each set of compared fields; and generating a tax data reconciliation report, the tax data reconciliation report including the comparison results for each of the compared fields.

According to another aspect, a computing system for reconciling tax data is provided, including a computing device with processing circuitry configured to execute instructions using portions of associated memory to implement a tax data reconciliation program. Implementation of the tax data reconciliation program causes the processing circuitry to receive a command to reconcile a first tax data set with a second tax data set. The command specifies one or more fields to be compared between the first tax data set and the second tax data set. The processing circuitry receives the first tax data set and the second tax data set. The first tax data set has a first tax data format, and the second tax data set has a second tax data format that is different from the first tax data format. The processing circuitry retrieves at least one stored configuration file containing a first key and a first data range for the first tax data set, and a second key and a second data range for the second data set. A tax data reconciliation algorithm is implemented to match records between the first tax data set and the second tax data set via the first key and the second key, compare fields in the first data range with corresponding fields in the second data range, and store comparison results for each set of compared fields. When the first tax data set and the second tax data set have different granularity levels, one of the first tax data set and the second tax data set is aggregated prior to comparing the fields in the first data range and the corresponding fields in the second data range. When the first data range and/or the second data range includes two or more columns, the two or more columns are concatenated into a single column prior to comparing the fields in the first data range in the first tax data set and the corresponding fields in the second data range in the second tax data set. A tax data reconciliation report is generated, including the comparison results for each set of compared fields, and the tax data reconciliation report is output to a client computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for reconciling tax data, according to an example implementation.

FIG. 2 shows an architecture diagram of a tax data reconciliation program, in accordance with the computing system of FIG. 1.

FIG. 3 shows example code for gathering configuration data, building a reconciliation data table, and retrieving comparison results, in accordance with the computing system of FIG. 1.

FIG. 4 shows example code for generating a tax data reconciliation report, in accordance with the computing system of FIG. 1.

FIG. 5 shows a flowchart for a method for reconciling tax data, according to an example implementation.

FIG. 6 shows a schematic view of an example computing environment in which the computing system of FIG. 1 may be enacted.

### DETAILED DESCRIPTION

Taxes are levied on numerous products, such as the production, extraction, sale, transfer, leasing, and/or delivery of goods, the rendering of services, and on the use of goods or permission to use goods to perform activities. Tax applications can help users manage clients and handle the complexities of determining tax rates for different types of taxes over a variety of products, as well as for multiple vendors and locations. However, when tax data sets are in different file formats, the reconciliation process typically involves manual comparison, which is time-consuming, subject to error, and often leads to rework. A technical challenge exists to provide an efficient, accurate computerized system and method for reconciling tax data across unlike file formats. To that end, the embodiments described herein relate to systems and methods for reconciling tax data from different sources and having different formats. It will be appreciated that the example implementations described herein and with reference to the figures are exemplary in nature and are thus not intended to limit the scope of the disclosure, as numerous variations of the provided implementations are possible.

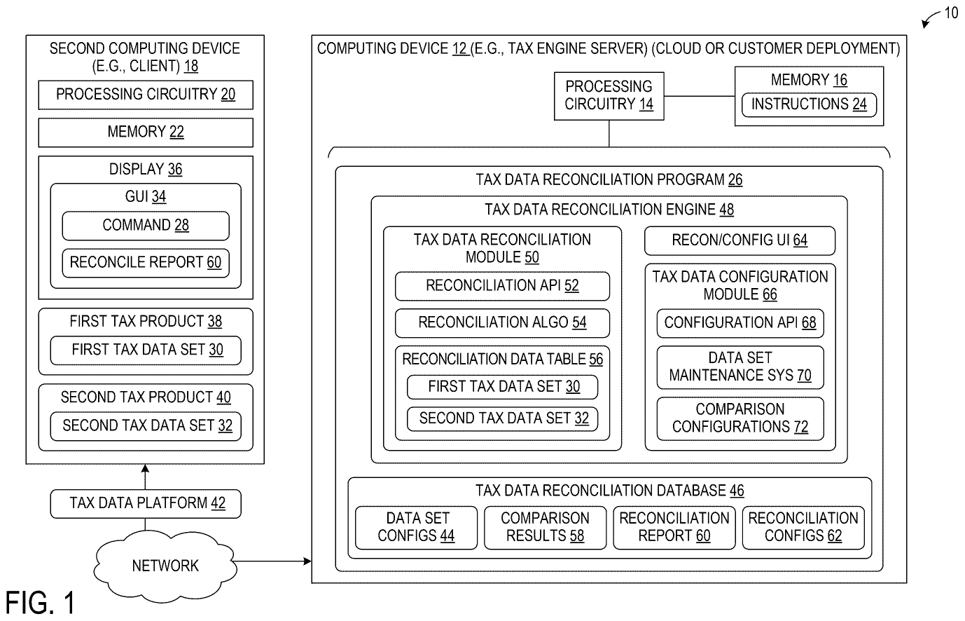

To address the issues described above, a computing system 10 for reconciling tax data is provided. Referring initially to FIG. 1, the computing system 10 includes at least one computing device. The computing system 10 is illustrated as having a first computing device 12 including processing circuitry 14 and memory 16, and a second computing device 18 including processing circuitry 20 and memory 22. The illustrated implementation is exemplary in nature, and other configurations are possible. In the description below, the first computing device will be described as a tax engine server 12 and the second computing device will be described as a client computing device 18, and respective functions carried out at each device will be described. It will be appreciated that in other configurations, the computing system 10 may include a single computing device that carries out the salient functions of both the server 12 and client computing device 18, and that the first computing device could be a computing device other than server. In other alternative configurations, functions described as being carried out at the server 12 may alternatively be carried out at the client computing device 18 and vice versa.

Continuing with FIG. 1, the processing circuitry 14 is configured to execute instructions 24 using portions of associated memory 16 to implement a tax data reconciliation program 26 hosted at the tax engine server 12. At a high level, the tax data reconciliation program 26 is designed to process tax data sets from different sources and having different formats, define keys and data ranges for each tax data set, match records between the tax data sets via the keys, compare fields in the corresponding data ranges, and generate a tax data reconciliation report. It will be appreciated that the term “product” as used herein may refer to goods, such as tangible products and digital products, as well as services.

The processing circuitry 14 is configured to receive a command 28 to reconcile a first tax data set 30 with a second tax data set 32, the command 28 specifying one or more fields to be compared between the first tax data set 30 and the second tax data set 32, as well as a location of the first and second tax data sets 30, 32. The command 28 may be received via a graphical user interface (GUI) 34 displayed on a display 36 of the client computing device 18.

Upon receiving the command to reconcile the first and second tax data sets 30, 32, the processing circuitry 14 receives the first tax data set 30 and the second tax data set 32. The embodiments described herein are directed to reconciling tax data sets in which the first tax data set 30 has a first tax data format, and the second tax data set 32 has a second tax data format that is different from the first tax data format. However, it will be appreciated that the tax data reconciliation program 26 retains the functionality to reconcile tax data sets having a same format.

The tax data sets 30, 32 may be returns or reports from one or more tax software products 38, 40, data sets from tax software products, and/or user-created data sets, for example. While FIG. 1 depicts the first and second tax data sets 30, 32 being from respective first and second tax products 38, 40 implemented on the client computing device 18, it will be appreciated that the first and second tax data sets 30, 32 may be from the same product or created by a user, and they may be implemented on the client computing device 18, the tax engine server 12, and/or a different computing device. The first and second tax products 38, 40 may be configured to share product data with an associated tax data platform 42, such as a centralized data platform that stores data across products of a tax management system.

To define the structure of the first and second tax data sets 30, 32 for reconciliation, the processing circuitry 14 retrieves at least one stored data set configuration 44 from a tax data reconciliation database 46 included in the tax data reconciliation program 26. The data set configuration 44 contains a first key and a first data range for the first tax data set 30, and a second key and a second data range for the second tax data set 32. The first and second keys may be one or more columns in the respective first and second tax data sets 30, 32.

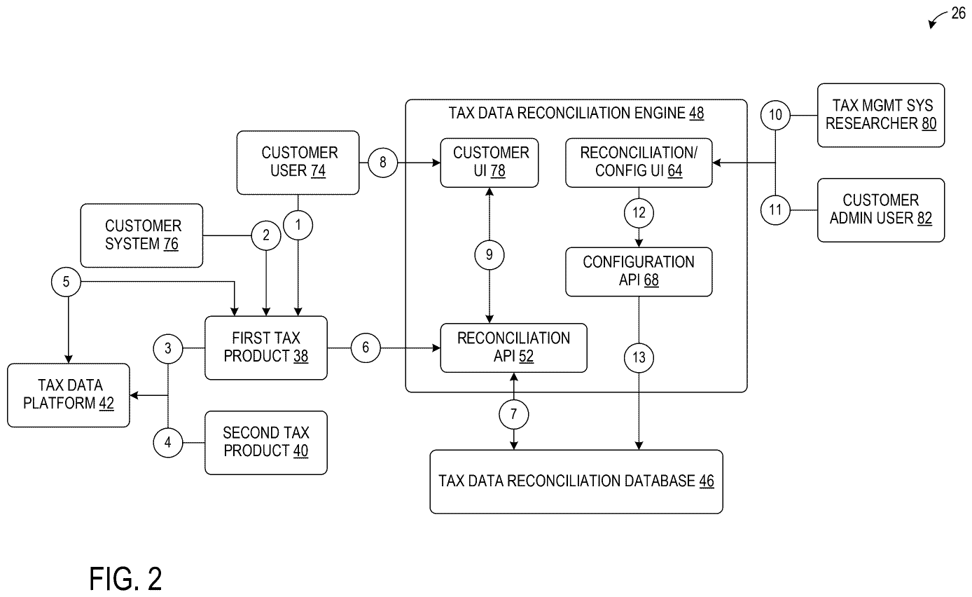

As described in detail with reference to FIG. 2, the tax data reconciliation program includes a tax data reconciliation engine 48 that provides the components for reconciling the tax data, as well as for managing reconciliation configurations and maintaining data sets and comparison configurations. A tax data reconciliation module 50 contains a reconciliation application programming interface (API) 52 that triggers a comparison between the first and second tax data sets 30, 32. To this end, the reconciliation API 52 implements a tax data reconciliation algorithm 54 that is configured to match records between the first and second tax data sets 30, 32 via the first and second keys, respectively, and compare fields in the first data range with corresponding fields in the second data range.

To compare the fields in the first and second data ranges, the tax data reconciliation algorithm 54 populates a reconciliation data table 56 with the fields in the first data range and the corresponding fields in the second data range in a text-based, human-readable, machine-readable format, e.g., JavaScript Object Notation (JSON), using a variant data type. The first and second tax data sets 30, 32 each comprise a plurality of rows of data. Each row of the plurality of rows of data in the first data range for the first tax data set 30 is inserted as a respective row in the reconciliation data table 56, and each row of the plurality of rows of data in the second data range for the second tax data set 32 is inserted as a respective row in the reconciliation data table 56. Using a variant data type for each column allows the comparison of values between the fields (i.e., rows in a respective column), regardless of the initial format, as the variant data type can hold any data type, such as text, integers, strings, floating-point numbers, arrays, and even user-defined data types, and can switch between data types. As such, storing the fields of each row of data in the first and second data ranges in a respective row in the reconciliation data table 56 in JSON format using a variant data type enables simple and efficient retrieval and comparison of the first and second tax data sets.

The first and second tax data sets 30, 32 are defined as left and right tax data sets, and matched based on the defined first and second keys. Fields in the left tax data set of the reconciliation data table 56 are comparison mapped to corresponding fields in the right tax data set of the reconciliation data table 56. The comparison results 58 are stored in a separate table in the tax data reconciliation database 46, along with a bitwise comparison result for each set of compared fields. For example, bitwise comparison results of “0001” would indicate that the field values for the first three sets of compared fields matched, but the value for the fourth set of compared fields did not.

A tax data reconciliation report 60 is generated to include comparison results 58 for each set of compared fields. The first tax data set 30, the second tax data set 32, and the tax data reconciliation report 60 are stored in the reconciliation database 46, and the tax data reconciliation report 60 is output to the client computing device 18 where it can be displayed in the GUI 34. The tax data reconciliation report 60 may be configured as a comma-separated values (CSV) file or a spreadsheet, for example, and viewed in a conventional spreadsheet program, with the mismatched or missing fields highlighted or left blank.

The identification of the first/left and second/right tax data sets 30, 32 and the definition of the mapping of the fields from each data set used for the comparison are recorded as a reconciliation configuration 62 and stored in the tax data reconciliation database 46. Storing the reconciliation configuration 62 that was used in a comparison in the tax data reconciliation database 46 at the tax engine server 12 helps prevent modifications to the reconciliation configuration 62, which would affect the existing comparison results 58 and tax data reconciliation report 60.

In some implementations, the at least one stored data set configuration 44 includes a granularity level for the first tax data set 30, and, when the first tax data set 30 and the second tax data set 32 have different granularity levels, one of the first and second tax data sets 30, 32 is aggregated prior to comparing the fields in the first data range and the corresponding fields in the second data range. The data set configuration 44 may further include a tolerance to prevent inaccuracies when comparing the fields in the first data range and the corresponding fields in the second data range. The tolerance may be, for example, a number to eliminate rounding mismatches or a percentage, as some values may vary depending upon the tax product.

Additionally, when the first data range and/or the second data range includes two or more columns in the respective native data set, the two or more columns are concatenated into a single column prior to comparing the fields in the first data range in the first tax data set 30 and the corresponding fields in the second data range in the second tax data set 32. It will be appreciated that this functionality is included in the tax data reconciliation algorithm 54

As shown in FIG. 1 and discussed in detail in FIG. 2, some implementations of the tax data reconciliation engine 48 may include a reconciliation/configuration user interface (UI) 64 and a tax data configuration module 66 that contains a configuration API 68, a data set maintenance system 70, and comparison configurations 72.

Turning to FIG. 2, an architecture diagram of the tax data reconciliation program 26 is shown. It will be appreciated that related components of the computing system 10 are also included. Moving stepwise through the diagram, tax data is uploaded to the first tax product 38 by a customer user 74 and/or a customer system 76 at (1) and (2), respectively. The customer system 76 may be a tax data system such as an enterprise resource planning (ERP) system. Respective product data from the first and second tax products 38, 40 is shared to the tax data platform 42, as depicted at (3) and (4) in FIG. 2. As discussed above, the tax data platform 42 may be configured to as a centralized data platform that stores data for products included in a tax management system.

When the command 28 to reconcile the first and second tax data sets 30, 32 is received, the first tax product 38 may fetch the data sets for reconciliation from the tax data platform 42, as shown at (5). The first tax data product 38 may then send a request (6) to the reconciliation API 52 to upload the first and second data sets 30, 32. The reconciliation API 52 may be configured as a Representational State Transfer (REST) API, and the request from the first tax data product 38 may be a RESTful API call. As described in detail above, the reconciliation API 52 implements the tax data reconciliation algorithm 54, and a comparison between the first and second tax data sets 30, 32 is performed, recorded, and stored in the tax data reconciliation database 46.

As shown at (7) in FIG. 2, in addition to storing the comparison results 58 in the tax data reconciliation database 46, the reconciliation API may be further configured to retrieve the comparison results 58 and/or the reconciliation report 60 from the tax data reconciliation database 46. The customer user 74 may send instructions (8) to display the comparison results 58 and/or the reconciliation report 60 in a customer UI 78 that is enabled to request and receive (9) the comparison results 58 and/or the reconciliation report 60 from the reconciliation API 52, such as in the GUI 34 of the client computing device 18, for example. The customer UI 78 may be configured to display only mismatching or missing fields, rather than a CSV file or spreadsheet including all of the fields. The discrepancies may be provided in a list format, or the like, to enable the customer user 74 to quickly identify discrepancies in data entries.

In some implementations, when corresponding fields in the first and second tax data sets 30, 32 have mismatched data, the tax data reconciliation program 26 may be configured to predict a correction. For example, if a field in the first tax data set 30 is populated with a number, a corresponding field in the second tax data set 32 is populated with a word, and the entry format for the field is a number, the tax data reconciliation program 26 may identify the discrepancy and predict that the field in the second tax data set 32 should be the same number as in the corresponding field of the first tax data set 30. The predicted correction may be presented in the customer UI 78 for confirmation or modification by the customer user 74.

As mentioned above, the tax data reconciliation program 26 may include the reconciliation/configuration UI 64. The reconciliation/configuration UI 64 may provide an interface by which a tax management system researcher 80 and/or a customer administration user 82 can manage reconciliation configuration data, as indicated by (10) and (11) in FIG. 2, respectively. For example, the tax management system researcher 80 may be a team member of tax management system engineer team that can generate, add, and/or modify reconciliation configurations 62 to address the needs of clients or improve the efficiency of reconciling complicated tax data. The customer administration user 82 may add custom reconciliation configurations 62 that are specific to a particular client's data. As such, this feature allows new reconciliation configurations 62 to be added to the system 10 without requiring any new code or code deployments.

The reconciliation/configuration UI 64 may be configured to make RESTful API calls (12) to the configuration API 68, which is designed to implement the data set maintenance system 70 to preserve data sets and comparison configurations 72 received from the tax management system researcher 80 and/or the customer administration user 82. As shown at (13) in FIG. 2, the configuration API 68 may upload the data sets and comparison configurations 72 to the tax data reconciliation database 46 for storage.

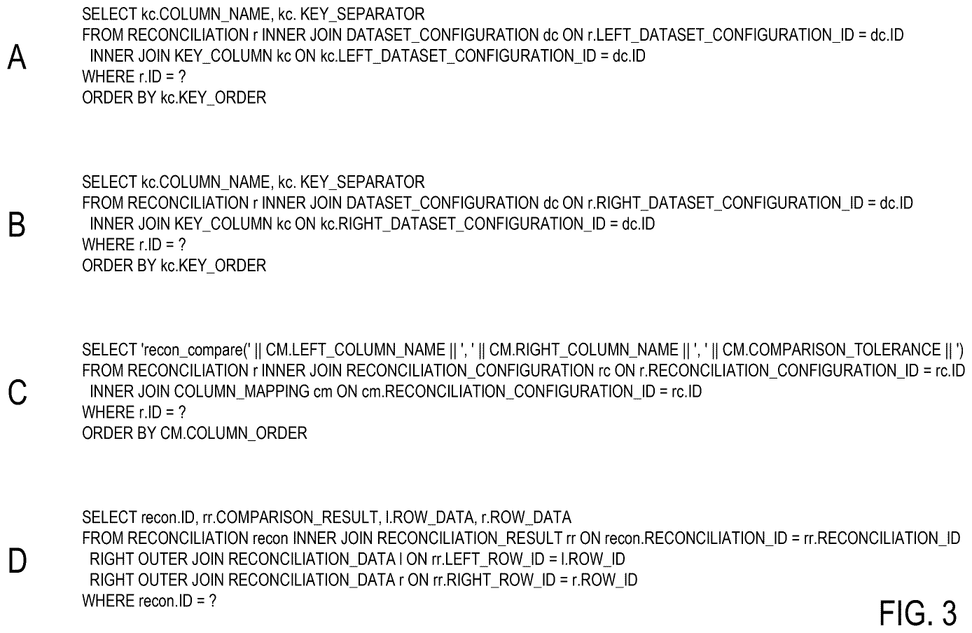

FIG. 3 shows example code for queries used in the tax reconciliation process. The queries illustrated in Panels A-D are run to gather configuration data and build a dynamic query for reconciling the tax data sets 30, 32. Specifically, Panel A shows a query that is used to define a key for a field in the left tax data set (i.e., first tax data set 30) of the reconciliation data table 56, and Panel B shows a query that is used to define a key for a field in the right tax data set (i.e., second tax data set 32). A query for column mapping according to the reconciliation configuration is shown in Panel C. As described above, fields in the left tax data set of the reconciliation data table 56 are comparison mapped to corresponding fields in the right tax data set of the reconciliation data table 56 based on the defined keys. The query shown in Panel D is used to retrieve the comparison results 58.

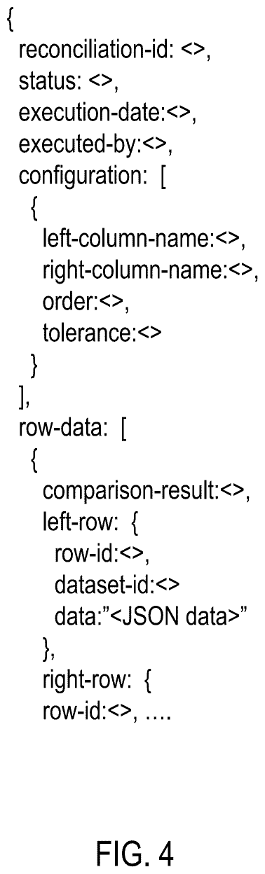

FIG. 4 shows example code for generating the tax data reconciliation report 60 from the comparison results 58. Specifically, the query illustrated in FIG. 4 is used to retrieve the comparison results 58 and apply configuration data such as an order and a tolerance to the tax data sets in respective columns of the reconciliation data table 56. Accordingly, the data set configuration 44 is retrieved in tandem with the comparison results 58 such that the reconciliation data is interpreted accurately. It will be appreciated that the code in FIG. 4 is not shown in its entirety and is merely an example of how a query for generating the tax data reconciliation report 60 may be formatted.

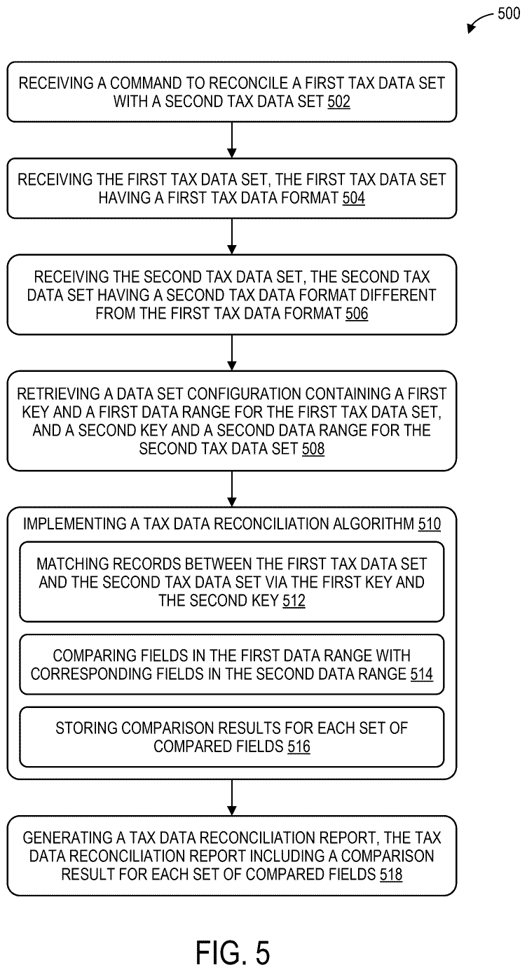

FIG. 5 shows a flowchart for a method 500 for reconciling tax data. The method 500 may be implemented by the computing system 10 illustrated in FIG. 1, or via other suitable hardware and software.

At step 502, the method 500 may include receiving a command to reconcile a first tax data set with a second tax data set, the command specifying one or more fields to be compared between the first tax data set and the second tax data set. As described in detail above, the command may be received via GUI displayed on a display of a client computing device.

Continuing from step 502 to step 504, the method 500 may include receiving the first tax data set, the first tax data set having a first file format.

Proceeding from step 504 to step 506, the method 500 may include receiving the second tax data set, the second tax data set having a second file format different from the first tax data format. The first and second tax data sets may be configured as returns or reports from one or more tax software products, data sets from tax software products, and/or user-created data sets. The first and second tax data sets may be received from respective first and second tax products, a same product, or created by a user, and they may be implemented on the client device, a server device, and/or a different computing device. The first and second tax products may be configured to share product data with a centralized data platform that stores data across products of a tax management system.

Advancing from step 506 to step 508, the method 500 may include retrieving at least one stored data set configuration containing a first key and a first data range for the first tax data set, and a second key and a second data range for the second tax data set. The first and second keys may be one or more columns in the respective first and second tax data sets. The method may further comprise including a granularity level for the first tax data set in the at least one stored data set configuration, and, when the first tax data set and the second tax data set have different granularity levels, aggregating one of the first tax data set and the second tax data set prior to reconciling the tax data sets. The method may further comprise including a tolerance in the data set configuration to prevent inaccuracies when comparing the fields in the first data range and the corresponding fields in the second data range.

Continuing from step 508 to step 510, the method 500 may include implementing a tax data reconciliation algorithm. As discussed in detail above, the tax data reconciliation program includes a tax data reconciliation engine that is designed to reconcile the tax data, as well as to manage reconciliation configurations and maintain data sets and comparison configurations

Proceeding from step 510 to step 512, the method 500 may include matching records between the first tax data set and the second tax data set via the first key and the second key. This step may be performed by implementing a tax data reconciliation algorithm that includes instructions for defining the first and second keys.

Advancing from step 512 to step 514, the method 500 may include comparing fields in the first data range with corresponding fields in the second data range. When the first data range and/or the second data range includes two or more columns, the method may include concatenating the two or more columns into a single column prior to comparing the fields in the first data range and the corresponding fields in the second data range. The method may further include populating a reconciliation data table with the fields in the first data range and the corresponding fields in the second data range in a text-based, human-readable, machine-readable format using a variant data type. Each of the first tax data set and the second tax data set may comprise a plurality of rows of data, and the method may further include inserting each row of the plurality of rows of data in the first data range for the first tax data set as a row in a reconciliation data table, and inserting each row of the plurality of rows of data in the second data range for the second tax data set as a row in the reconciliation data table.

Continuing from step 514 to step 516, the method 500 may include storing comparison results for each set of compared fields. As discussed above, the comparison results may be stored in a separate table in the tax data reconciliation database, along with a bitwise comparison result for each set of compared fields.

Advancing from step 516 to step 518, the method 500 may include generating a tax data reconciliation report, the tax data reconciliation report including comparison results for each set of compared fields. The comparison results may include a bitwise comparison result for each set of compared fields. The method may further include outputting the tax data reconciliation report to the client computing device.

Using the above described systems and methods, users can reconcile tax data housed within client systems, tax data uploaded to a third-party product by customers, and additional tax data from the same and other third-party products, regardless of format. The claimed tax data reconciliation process reduces errors and rework by allowing users to easily find data discrepancies and correct errors prior to taking action, such as submitting a tax return.

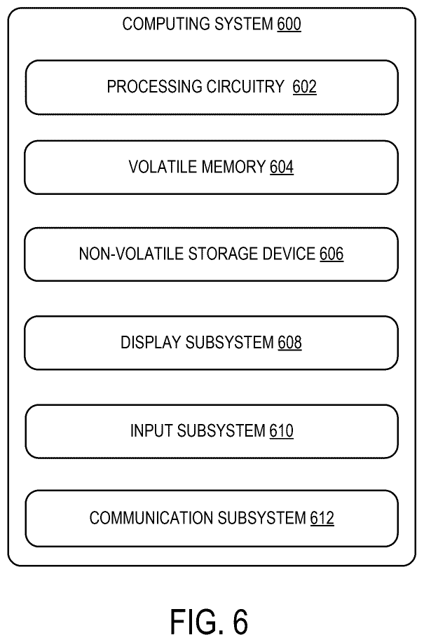

FIG. 6 schematically shows a non-limiting embodiment of a computing system 600 that can enact one or more of the methods and processes described above. Computing system 600 is shown in simplified form. Computing system 600 may embody the computing system 10 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 602.

Non-volatile storage device 606 includes one or more physical devices configured to hold instructions executable by the processing circuitry to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for reconciling tax data, the computing system comprising:
a computing device including processing circuitry configured to execute instructions using portions of associated memory to implement a tax data reconciliation program, causing the processing circuitry to:
receive a command to reconcile a first tax data set with a second tax data set, the command specifying one or more fields to be compared between the first tax data set and the second tax data set;
receive the first tax data set, the first tax data set having a first tax data format;
receive the second tax data set, the second tax data set having a second tax data format different from the first tax data format;
retrieve at least one stored data set configuration containing a first key and a first data range for the first tax data set, and a second key and a second data range for the second tax data set;
implement a tax data reconciliation algorithm, the tax data reconciliation algorithm being configured to:
match records between the first tax data set and the second tax data set via the first key and the second key,
compare fields in the first data range with corresponding fields in the second data range, and
store comparison results for each set of compared fields; and
generate a tax data reconciliation report, the tax data reconciliation report including the comparison results for each set of compared fields.

2. The computing system of claim 1, wherein
the tax data reconciliation algorithm being configured to populate a reconciliation data table with the fields in the first data range and the corresponding fields in the second data range in a text-based, human-readable, machine-readable format using a variant data type.

3. The computing system of claim 1, wherein
each of the first tax data set and the second tax data set comprises a plurality of rows of data,
each row of the plurality of rows of data in the first data range for the first tax data set is inserted as a respective row in a reconciliation data table, and
each row of the plurality of rows of data in the second data range for the second tax data set is inserted as a respective row in the reconciliation data table.

4. The computing system of claim 1, wherein
the comparison results include a bitwise comparison result for each set of compared fields.

5. The computing system of claim 1, wherein
the at least one stored data set configuration includes a granularity level for the first tax data set, and
when the first tax data set and the second tax data set have different granularity levels, one of the first tax data set and the second tax data set is aggregated prior to comparing the fields in the first data range and the corresponding fields in the second data range.

6. The computing system of claim 1, wherein,
when the first data range and/or the second data range includes two or more columns, the two or more columns are concatenated into a single column prior to comparing the fields in the first data range and the corresponding fields in the second data range.

7. The computing system of claim 1, wherein
the data set configuration includes a tolerance to prevent inaccuracies when comparing the fields in the first data range and the corresponding fields in the second data range.

8. The computing system of claim 1, wherein
the first tax data set, the second tax data set, and the tax data reconciliation report are stored in a reconciliation database.

9. The computing system of claim 1, wherein
the tax data reconciliation report is output to a client computing device.

10. A method for reconciling tax data, the method comprising:
receiving a command to reconcile a first tax data set with a second tax data set, the command specifying one or more fields to be compared between the first tax data set and the second tax data set;
receiving the first tax data set, the first tax data set having a first file format;
receiving the second tax data set, the second tax data set having a second file format different from the first tax data format;
retrieving at least one stored data set configuration containing a first key and a first data range for the first tax data set, and a second key and a second data range for the second tax data set;
implementing a tax data reconciliation algorithm, the tax data reconciliation algorithm being configured to perform the steps of:
matching records between the first tax data set and the second tax data set via the first key and the second key,
comparing fields in the first data range with corresponding fields in the second data range, and
storing comparison results for each set of compared fields; and
generating a tax data reconciliation report, the tax data reconciliation report including the comparison results for each set of compared fields.

11. The method of claim 10, the method further comprising:
populating a reconciliation data table with the fields in the first data range and the corresponding fields in the second data range in a text-based, human-readable, machine-readable format using a variant data type.

12. The method of claim 10, wherein
each of the first tax data set and the second tax data set comprises a plurality of rows of data, and
the method further comprises:
inserting each row of the plurality of rows of data in the first data range for the first tax data set as a row in a reconciliation data table, and
inserting each row of the plurality of rows of data in the second data range for the second tax data set as a row in the reconciliation data table.

13. The method of claim 10, the method further comprising:
including in the comparison results a bitwise comparison result for each set of compared fields.

14. The method of claim 10, the method further comprising:
including a granularity level for the first tax data set in the at least one stored data set configuration, and
when the first tax data set and the second tax data set have different granularity levels, aggregating one of the first tax data set and the second tax data set prior to comparing the fields in the first data range and the corresponding fields in the second data range.

15. The method of claim 10, the method further comprising:
when the first data range and/or the second data range includes two or more columns, concatenating the two or more columns into a single column prior to comparing the fields in the first data range and the corresponding fields in the second data range.

16. The method of claim 10, the method further comprising:
including a tolerance in the data set configuration to prevent inaccuracies when comparing the fields in the first data range and the corresponding fields in the second data range.

17. The method of claim 10, the method further comprising:
storing the first tax data set, the second tax data set, and the tax data reconciliation report in a reconciliation database.

18. The method of claim 10, the method further comprising:
outputting the tax data reconciliation report to a client computing device.

19. A computing system for reconciling tax data, the computing system comprising:
a computing device including processing circuitry configured to execute instructions using portions of associated memory to implement a tax data reconciliation program, causing the processing circuitry to:
receive a command to reconcile a first tax data set with a second tax data set, the command specifying one or more fields to be compared between the first tax data set and the second tax data set;
receive the first tax data set, the first tax data set having a first tax data format;
receive the second tax data set, the second tax data set having a second tax data format different from the first tax data format;
retrieve at least one stored data set configuration containing a first key and a first data range for the first tax data set, and a second key and a second data range for the second tax data set;
implement a tax data reconciliation algorithm, the tax data reconciliation algorithm being configured to:
match records between the first tax data set and the second tax data set via the first key and the second key,
compare fields in the first data range with corresponding fields in the second data range, and
store comparison results for each set of compared fields;
generate a tax data reconciliation report, the tax data reconciliation report including the comparison results for each set of compared fields; and
output the tax data reconciliation report to a client computing device, wherein
when the first tax data set and the second tax data set have different granularity levels, one of the first tax data set and the second tax data set is aggregated prior to comparing the fields in the first data range and the corresponding fields in the second data range, and
when the first data range and/or the second data range includes two or more columns, the two or more columns are concatenated into a single column prior to comparing the fields in the first data range in the first tax data set and the corresponding fields in the second data range in the second tax data set.

20. The computing system of claim 19, wherein
the data set configuration includes a tolerance to prevent inaccuracies when comparing the fields in the first data range and the corresponding fields in the second data range.
